(19) United States
(12) Patent Application Publication
(10) Pub. No.: US 2016/0358621 A1
(43) Pub. Date: Dec. 8, 2016

(54) Self-Servo Write Non-Reference Head Position Measuring

(71) Applicant: HGST Netherlands B.V., Amsterdam (NL)

(72) Inventor: James B. French, JR., Longmont, CO (US)

(21) Appl. No.: 14/730,206

(22) Filed: Jun. 3, 2015

(51) Int. Cl. G11B 5/596

(52) U.S. Cl. CPC G11B 5/59666

(57) ABSTRACT

An approach to self-servo writing (SSW) in a hard disk drive involves receiving a first signal from a first reader reading from a first disk media surface while concurrently receiving a second signal from a second reader reading from a second disk media surface, where the relative position of the first and second readers is determinable based on the first and second signals. For example, the first signal may correspond to the SSW reference head while the second signal may correspond to any one of the other SSW non-reference heads, during a SSW bank writing procedure, whereby the relative position and/or motion between the reference and non-reference heads can have a deleterious effect on the servo track writing quality. Because multiple different non-reference heads may be selected for signal reception and associated position determination, the first and second disk media surfaces may be constituent to different disks.

### FIELD OF EMBODIMENTS

Embodiments of the invention may relate generally to hard disk drives and more particularly to an approach to measuring the position of a non-reference head in a self-servo write process.

### BACKGROUND

A hard-disk drive (HDD) is a non-volatile storage device that is housed in a protective enclosure and stores digitally encoded data on at least one circular disk having magnetic surfaces. When an HDD is in operation, each magnetic-recording disk is rapidly rotated by a spindle system. Data is read from and written to a magnetic-recording disk using a read-write head that is positioned over a specific location of a disk by an actuator. A read-write head uses a magnetic field to read data from and write data to the surface of a magnetic-recording disk. A write head makes use of the electricity flowing through a coil, which produces a magnetic field. Electrical pulses are sent to the write head, with different patterns of positive and negative currents. The current in the coil of the write head induces a magnetic field across the gap between the head and the magnetic disk, which in turn magnetizes a small area on the recording medium.

Increasing areal density, a measure of the quantity of information bits that can be stored on a given area of disk surface, is one of the ever-present goals of HDD design evolution. Truer, more ideal writing of the data tracks corresponding to the recording media can further the cause of increasing the areal density, where ideal tracks are circular and concentric. The technology utilized for data track writing is generally referred to as servo track writing, technology that magnetically writes the servo positioning information used to position the head over the data track.

Servo track writing typically falls into one of two categories: (a) external writing, in which the positioning information is written while the recording disk is outside of the HDD; and (b) internal writing, in which the positioning information is written while the disk is already inside the HDD using the HDD's own read-write heads. The quality of servo track writing can be characterized based on the accuracy of the servo tracks that are written, for example, the circularity of the track and the positioning of a track relative to adjacent tracks. The presence of sub-optimal tracks may result in repeatable run-out (RRO), e.g., with non-circularity, and track misregistration (TMR), e.g., with relatively mispositioned tracks. Thus, the overall quality of servo track writing remains an ongoing challenge in the development and manufacturing of HDDs.

Any approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF EMBODIMENTS

Embodiments of the invention are generally directed toward an approach to self-servo writing (SSW) in a hard disk drive, wherein a first signal is received from a first reader reading from a first disk media surface, a second signal is concurrently received from a second reader reading from a second disk media surface, and the relative position of the first and second readers is determined based on the first and second signals. For example, the first signal may correspond to the SSW reference head while the second signal may correspond to any one of the other SSW non-reference heads, during a SSW bank writing procedure, whereby the relative position and/or motion between the reference and non-reference heads can have a deleterious effect on the track writing quality.

According to embodiments, multiple different non-reference heads may be selected for signal reception and associated position determination. Therefore, and according to embodiments, the first and second disk media surfaces may be constituent to the same disk media or constituent to different disk media.

Embodiments discussed in the Summary of Embodiments section are not meant to suggest, describe, or teach all the embodiments discussed herein. Thus, embodiments of the invention may contain additional or different features than those discussed in this section. Furthermore, no limitation, element, property, feature, advantage, attribute, or the like expressed in this section, which is not expressly recited in a claim, limits the scope of any claim in any way.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive (HDD), according to an embodiment;

FIG. 2 is a perspective view illustrating a self-servo write (SSW) bank writing process, according to an embodiment;

FIG. 3 is a perspective view illustrating a well-written track, according to an embodiment;

FIG. 4 is a perspective view illustrating a poorly-written track, according to an embodiment; and

FIG. 5 is a flow diagram illustrating a method for self-servo writing in a hard disk drive, according to an embodiment.

### DETAILED DESCRIPTION

Approaches to a self-servo write process in a hard disk drive are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### PHYSICAL DESCRIPTION OF ILLUSTRATIVE OPERATING CONTEXT

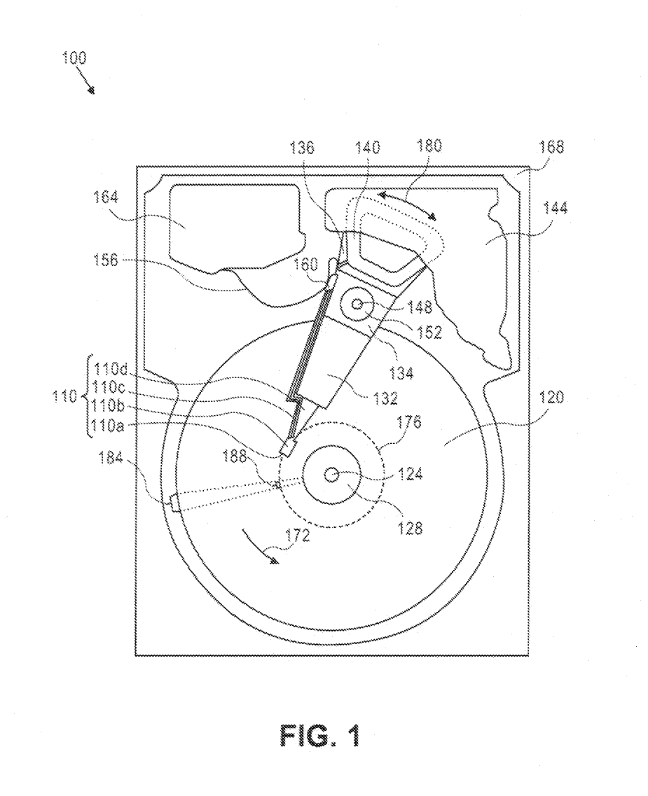

Embodiments may be used in the context of performing a self-servo write (SSW) bank writing process within a hard disk drive (HDD) storage device. Thus, in accordance with an embodiment, a plan view illustrating an HDD 100 is shown in FIG. 1 to illustrate an exemplary operating context.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one magnetic-recording medium 120 rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134 and a stator 144 including a voice-coil magnet (not visible). The armature 136 of the VCM is attached to the carriage 134 and is configured to move the arm 132 and the HGA 110, to access portions of the medium 120, being mounted on a pivot-shaft 148 with an interposed pivot bearing assembly 152. In the case of an HDD having multiple disks, the carriage 134 is called an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM coil) to which the actuator arm is coupled, may be collectively referred to as a head stack assembly (HSA). An HSA may, however, include more or fewer components than those described. For example, an HSA may refer to an assembly that further includes electrical interconnection components, a preamplifier, etc. Generally, an HSA is the assembly configured to move the head slider to access portions of the medium 120 for read and write operations.

With further reference to FIG. 1, electrical signals (e.g., current to the voice coil 140 of the VCM) comprising a write signal to and a read signal from the head 110a, are provided by a flexible interconnect cable 156 (“flex cable”). Interconnection between the flex cable 156 and the head 110a may be provided by an arm-electronics (AE) module 160, which may have an on-board pre-amplifier as well as other read-channel and write-channel electronic components (collectively, “data channel”). The AE 160 may be attached to the carriage 134 as shown. The flex cable 156 is coupled to an electrical-connector block 164, which provides electrical communication through electrical feedthroughs provided by an HDD housing 168. The HDD housing 168, also referred to as a base, in conjunction with an HDD cover provides a sealed, protective enclosure for the information storage components of the HDD 100.

Other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested, concentric tracks arranged in sectors on the medium 120, such as sector 184. Correspondingly, each track is composed of a plurality of sectored track portions (or “track sector”), for example, sectored track portion 188. Each sectored track portion 188 may be composed of recorded data and a header containing a servo-burst-signal pattern (“servo burst”), for example, an ABCD-servo-burst-signal pattern, which is information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

An HDD's electronic architecture comprises numerous electronic components for performing their respective functions for operation of an HDD, such as a hard disk controller (“HDC”), an interface controller, an arm electronics module, a data channel, a motor driver, a servo processor, buffer memory, etc. Two or more of such components may be combined on a single integrated circuit board referred to as a “system on a chip” (“SOC”). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass a data storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management and control of the different types of storage media typically differs, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### SELF-SERVO WRITING

As discussed, ideal tracks on a magnetic recording disk are circular and concentric. One approach to servo track writing involves internal writing, by which the servo positioning information, which effectively defines the tracks, is written using the HDD's own read-write heads while the disks are inside the HDD, i.e., a procedure that is often referred to as self-servo writing (SSW). A SSW process may take anywhere from hours to days to complete.

An SSW process may involve bank writing, whereby the position of one arm and its corresponding read-write head is tightly controlled (i.e., the “reference head” or “propagation head”) by reading a special servo pattern that is written to the disk during the propagation process and utilized to control the actuator, and whereby the remaining arms that are mechanically coupled via a shared carriage (i.e., the “non-reference heads” or “non-propagation heads”) are not directly controlled while all these non-reference heads are writing their product servo patterns at the same time as the reference head.

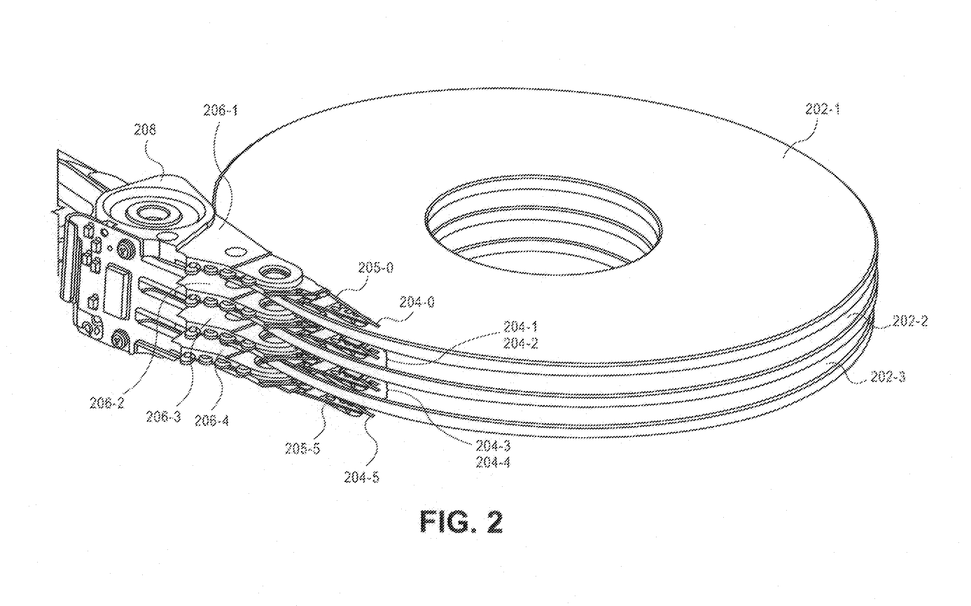

FIG. 2 is a perspective view illustrating a self-servo write (SSW) bank writing process, according to an embodiment. FIG. 2 depicts a plurality of magnetic recording disks 202-1, 202-2 through 202-n (here, 202-3), a surface of each of which is serviced by a corresponding read-write head 204-0 through 204-m (here, 204-5), where the number of disks, n, and the number of heads, m, may vary from implementation to implementation. Each read-write head 204-0 through 204-m is associated with a corresponding suspension 205-0 through 205-m (here, 205-5). In this example, disk 202-1 is serviced by heads 204-0 and 204-1, disk 202-2 is serviced by heads 204-2 and 204-3, and disk 202-3 is serviced by heads 204-4 and 204-5. In this example, adjacent heads 204-1 and 204-2 are coupled to the same arm 206-2, and adjacent heads 204-3 and 204-4 are coupled to the same arm 206-3, and where the single head 204-0 is coupled to arm 206-1 and the single head 204-5 is coupled to arm 206-4.

Typically, an inner middle head such as head 204-2 is selected as the reference head because that optimizes the respective distances between the reference head and each of the non-reference heads, such as heads 204-0, 204-1, 204-3, 204-4, 204-5. Because the non-reference heads are not directly controlled, rather they move along with the controlled reference head because all the heads are ganged together via the common carriage 208, it is desirable but not realistic to expect no motion or displacement of the non-reference heads relative to the reference head, especially in view of the configuration in which each head (e.g., 204-0 through 204-5) is coupled with a corresponding suspension (e.g., 205-0 through 205-5) that is attached (e.g., swaged) to a corresponding arm (e.g., arm 206-1 through 206-4).

As discussed, bank writing involves tightly controlling the position of one arm and its corresponding read-write head (e.g., head 204-2) by reading a special servo pattern that is written to the disk during the SSW process, and the remaining arms (and their corresponding heads) that are mechanically coupled via a shared carriage (e.g., carriage 208) are not directly controlled while all these non-reference heads (e.g., heads 204-0, 204-1, 204-3, 204-4, 204-5) are writing their servo patterns along with the reference head. Consequently, the reference head 204-2 maintains relatively tight and stable positioning control while there can be relative motion of the arms, suspensions and heads whose positions are not being controlled relative to the arm that is being tightly controlled, generally because the actuator (e.g., the carriage 208 and arms 206-1 through 206-4) is not perfectly rigid and the respective suspensions (e.g., 205-0 through 205-5) are typically mechanically coupled to their corresponding arms. Furthermore, the relative position and/or cross-head motion between the reference and non-reference heads may vary over time, and may be a result of other active external disturbances or forces, such as external shock, the reference head control system compensation, thermal changes, and the like. Historically, information about this relative motion between non-reference heads and the reference head during the SSW process has been unavailable and, therefore, the relative motion has been relatively uncontrollable and/or uncompensatable.

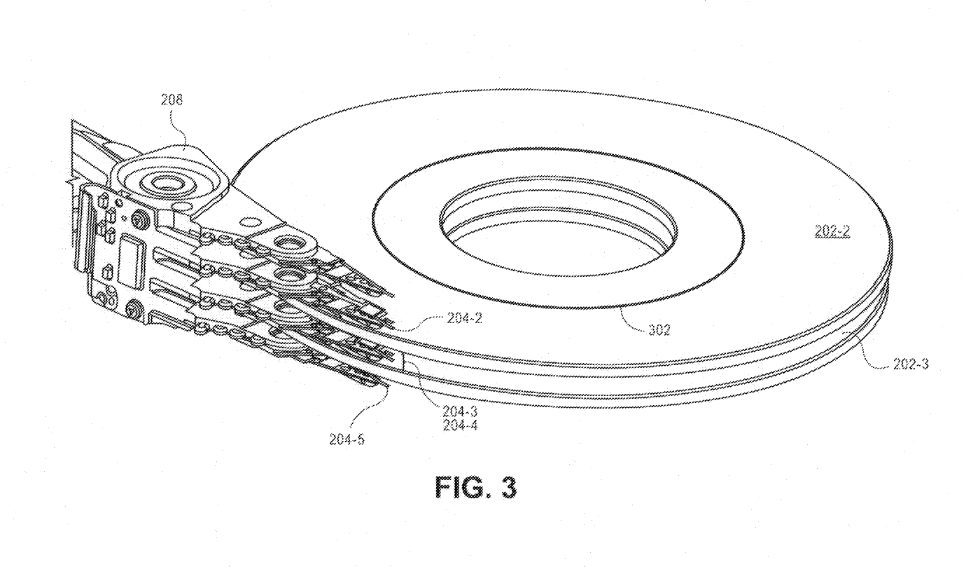

FIG. 3 is a perspective view illustrating a well-written track, according to an embodiment. Note that the top disk, disk 202-1 (FIG. 2) is removed from the view of FIG. 3. Thus, in the example depicted in FIG. 3, the tightly controlled reference head 204-2 writes the tracks, including track 302, to the upper surface of disk 202-2. Typically, the tracks written by the reference head such as head 204-2 are consistently circular and concentric as depicted in FIG. 3. Thus, these well-written tracks that are written by the reference head do not typically squeeze into each other (a phenomenon referred to as “track squeeze”) and, therefore, are more reliable tracks to write data to and read data from. Generally, the more well-written the tracks the higher the areal density that can be achieved. A disk may have a number of different types of tracks, such as raw servo tracks, gray code tracks, adjusted servo tracks, data tracks, and the like, for non-limiting examples, each and all of which may be referred to herein simply as “tracks”.

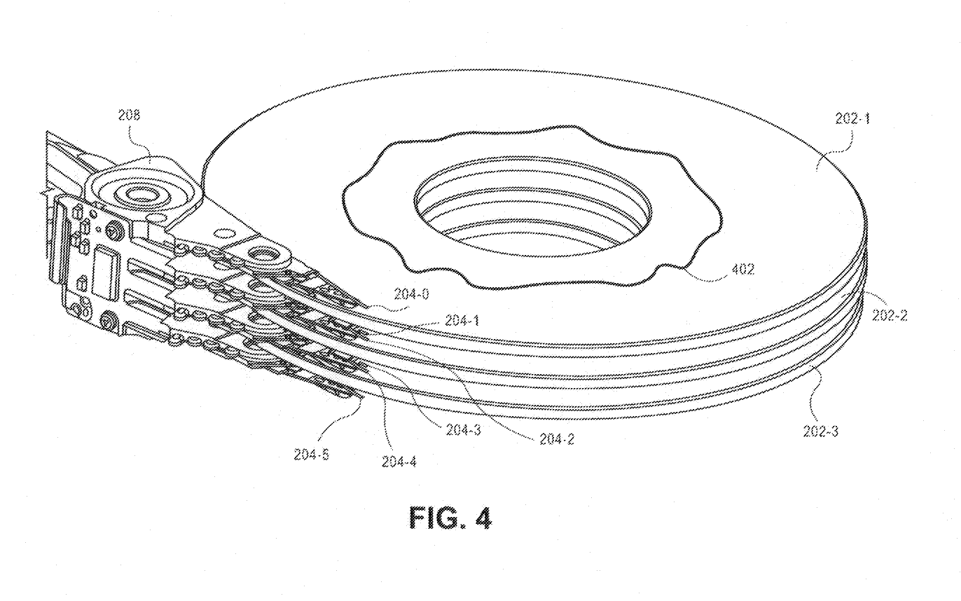

However, as discussed, tracks written by a non-reference head can deviate from the ideal (e.g., depicted as track 302 of FIG. 3) due to the relative motion and/or relative displacement between the reference head and the non-reference heads. FIG. 4 is a perspective view illustrating a poorly-written track, according to an embodiment. FIG. 4 continues with the example described in reference to FIG. 3. Thus, the tightly controlled reference head 204-2 remains the head that writes the tracks, including track 302 (FIG. 3), to the upper surface of disk 202-2. However, shown in FIG. 4 is a poorly-written track 402 that is written by a non-reference head 204-0 to the upper surface of disk 202-1. In this example, the tracks written by the non-reference head such as head 204-0 are at times not accurately circular and concentric, such as generally depicted by poorly-written track 402. Thus, these poorly-written tracks that are written by the non-reference heads may squeeze into each other and, therefore, are less reliable tracks to write data to and read data from than are the well-written tracks written by the reference head (e.g., track 302 of FIG. 3), and inhibit the growth of the areal density. In part because the relative position and motion between reference and non-reference heads may vary over time, likewise, the manifestation of track squeeze may vary over the duration of the SSW process and, therefore, vary across tracks across a particular disk surface and across the multiple disks contained within a given HDD.

### METHOD FOR SELF-SERVO WRITING

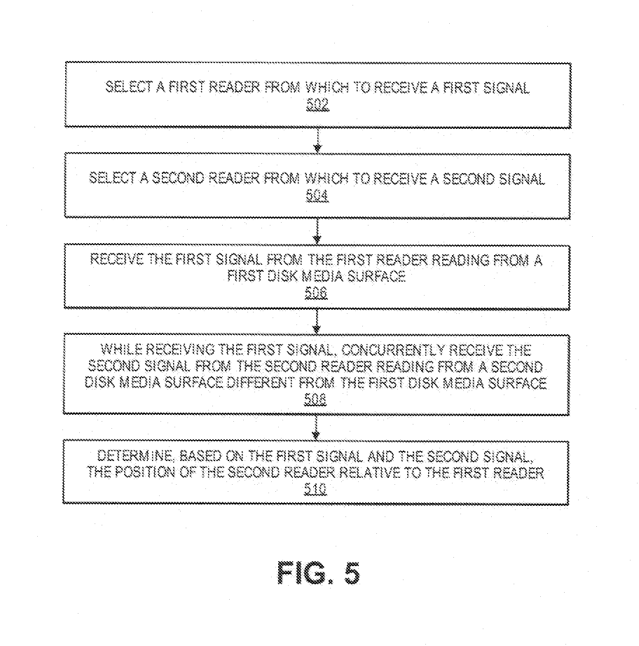

FIG. 5 is a flow diagram illustrating a method for self-servo writing in a hard disk drive, according to an embodiment. The process described in reference to FIG. 5 may be performed by a hard disk drive, for example. Further, at least portions of the process described in reference to FIG. 5 may be performed by an electronic component including control circuitry, such as a preamplifier for a non-limiting example, while other portions of the process may be performed by one or more processors, a microcontroller, a programmable device, an SOC (“system on a chip”), and the like.

At block 502, a first reader from which to receive a first signal is selected and, at block 504, a second reader from which to receive a second signal is selected. For example and with reference to FIG. 2, an HDD preamplifier may select to receive a first signal from the reader of the SSW reference head (e.g., head 204-2) and to receive a second signal from a reader of an SSW non-reference head (e.g., any of heads 204-0, 204-1, and 204-3 through 204-m).

At block 506, a first signal is received from the first reader, which is reading from a first disk media surface. For example, a read signal containing position data (e.g., based on non-production and/or production servo data) is received from the reader of the reference head 204-2, e.g., from the tightly controlled SSW propagation head which is controlling the position of the propagation head as well as the non-propagation heads, via the voice coil motor actuator, during the bank writing procedure.

At block 508, while receiving the first signal from the first reader, the second signal is concurrently received from the second reader, which is reading from a second disk media surface that is different from the first media surface. For example, a read signal containing position data (e.g., based on non-production and/or production servo data) is received from the reader of a non-reference head 204-0, e.g., from a dependent SSW non-propagation head. Significantly, the preamplifier, for example, is simultaneously receiving two different read signals from two different readers that are reading two different disk surfaces.

According to an embodiment, the two different disk surfaces from which the first reader and the second reader are respectively reading, correspond to two different sides of the same disk. For example, a first read signal may be received from reference head 204-2 reading the top surface of disk 202-2 (FIG. 2 and FIG. 3) while concurrently a second read signal may be received from the non-reference head 204-3 (FIG. 2) reading the bottom surface of disk 202-2.

According to an embodiment, the two different disk surfaces from which the first reader and the second reader are respectively reading, correspond to two different disks. For example, a first read signal may be received from reference head 204-2 reading the top surface of disk 202-2 (FIG. 2 and FIG. 3) while concurrently a second read signal may be received from any of the non-reference heads 204-0, 204-1, 204-4, 204-5 (FIG. 2) reading the respective surface of a different disk, such as disk 202-1, 202-3 (FIG. 2). Therefore, the second signal from the second reader, and the corresponding head and disk surface from which the second signal is read, are not limited to the two sides of a given disk. Consequently, an SSW process may be implemented in which read signals from various non-reference heads (“second signals”) are cycled through for reception simultaneous with reception of the read signal from the reference head (“first signal”).

The manner in which the foregoing steps (blocks 502-508) are implemented may vary from implementation to implementation. For example, preamplifier integrated circuit architecture/logic may be modified to implement the foregoing steps.

At block 510, based on the first signal (selected at block 502 and received at block 506) and the second signal (selected at block 504 and received at block 508), the position of the second reader relative to the first reader is determined. Thus, the position and/or motion of an SSW non-reference head relative to the SSW reference head is determinable based on a comparison of the respective read signals, e.g., the respective position data contained in the read signals. Consequently, the relative motion or position of the non-reference head may be compensated for or otherwise managed, in the context of writing more ideal (e.g., circular and concentric) tracks by any and/or all of the non-reference heads.

The manner in which the foregoing step corresponding to block 510 is implemented may vary from implementation to implementation. For example, the comparison and computations associated with determining the relative position or motion of the second reader relative to the first reader may be implemented for execution by a preamplifier, as well as one or more processors, a microcontroller, a programmable device, an SOC (“system on a chip”), and the like. Furthermore, the different actions corresponding to the different blocks illustrated in FIG. 5 may be performed by a single electronic component or by a plurality of different components within a hard disk drive. As such, the process described in reference to FIG. 5 may include an action of passing at least one signal, based on the first read signal (received at block 506) and the second read signal (received at block 508), e.g., to another logic circuit or to a processor, for determining the relative motion or position between the first reader and the second reader.

According to an embodiment, after selecting the second reader from which to receive the second signal (block 504) and receiving the second signal (block 508), a third reader is selected, from which to receive a third signal from reading from a third disk surface concurrently with receiving the first signal from the first reader, where the third disk surface is different from the second disk surface. Further, based on the first signal and the third signal, the position and/or motion of the third reader relative to the first reader is determined. Thus, reiterating, an SSW process may be implemented in which read signals from various non-reference heads (“second signal”, “third signal”, and so on) are cycled through for simultaneous reception along with reception of the read signal from the reference head (“first signal”). Stated otherwise, while receiving read/position signals from the reference head, the system is capable of switching among each and any of the non-reference heads for receiving a read/position signal therefrom, for use in determining the presence and amount of any cross-head motion between the reference head and a respective non-reference head. Furthermore, this SSW multiple-read head switching procedure may be used to monitor the positions of various non-reference heads constantly throughout the SSW process.

### EXTENSIONS AND ALTERNATIVES

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

1. A method for self-servo writing in a hard disk drive, the method comprising:
selecting a first reader from which to receive a first signal;
selecting a second reader from which to receive a second signal;
receiving said first signal from said first reader reading from a first disk media surface; and
while receiving said first signal, concurrently receiving said second signal from said second reader reading from a second disk media surface different from said first disk media surface; and
determining, based on said first signal and said second signal, the position of said second reader relative to said first reader.

2. The method of claim 1, wherein receiving said first signal and concurrently receiving said second signal includes receiving a first position signal from a reference head corresponding to said self-servo write process and concurrently receiving a second position signal from a non-reference head corresponding to said self-servo write process.

3. The method of claim 2, further comprising:
after selecting said second reader from which to concurrently receive said second signal, selecting a third reader from which to receive a third signal from said third reader reading from a third disk media surface concurrently with receiving said first position signal from said first reader, wherein said third reader is different from said second reader and said third disk media surface is different from said second disk media surface; and
determining, based on said first position signal and said third signal, the position of said third reader relative to said first reader.

4. The method of claim 2, further comprising:
controlling the position of said reference head and said non-reference head based on said first position signal.

5. The method of claim 1, wherein said first disk media surface is from a first disk media and said second disk media surface is from a second disk media different from said first disk media.

6. The method of claim 1, wherein said first disk media surface and said second disk media surface are opposing sides of the same disk media.

7. A hard disk drive comprising:
a plurality of recording disk media rotatably mounted on a spindle;
a plurality of read-write head sliders each comprising a reader configured to read from and a writer configured to write to at least one of said disk media;
a voice coil actuator configured to move said head slider to access portions of said disk medium; and
at least one electronic component comprising one or more sequences of instructions which, when executed by one or more processors, cause performance of:
receiving a first read signal from a first reader, corresponding to a first head slider, reading from a first disk media surface,
while receiving said first signal, concurrently receiving a second read signal from a second reader, corresponding to a second head slider, reading from a second disk media surface different from said first disk media surface, and
determining, based on said first signal and said second signal, the position of said second reader relative to said first reader.

8. The hard disk drive of claim 7, said one or more sequences of instructions which, when executed by one or more processors, cause performance of:
selecting said first reader from which to receive said first read signal, and
selecting said second reader from which to concurrently receive said second read signal.

9. The hard disk drive of claim 7, wherein receiving said first read signal and concurrently receiving said second read signal includes receiving a first position signal from a reference head during a self-servo write process and concurrently receiving a second position signal from a non-reference head during said self-servo write process.

10. The hard disk drive of claim 9, said one or more sequences of instructions which, when executed by one or more processors, cause performance of:
after selecting said second reader from which to concurrently receive said second signal, selecting a third reader from which to receive a third signal from said third reader reading from a third disk media surface concurrently with receiving said first position signal from said first reader, wherein said third reader is different from said second reader and said third disk media surface is different from said second disk media surface; and
determining, based on said first position signal and said third signal, the position of said third reader relative to said first reader.

11. The hard disk drive of claim 9, said one or more sequences of instructions which, when executed by one or more processors, cause performance of:
controlling the position of said reference head and said non-reference head while servo writing, using said voice coil actuator, based on said first position signal.

12. The hard disk drive of claim 7, wherein said first disk media surface is from a first disk media and said second disk media surface is from a second disk media different from said first disk media.

13. A hard disk drive integrated circuit comprising one or more sequences of instructions which, when executed by one or more processors, cause performance of:
receiving a first read signal from a first reader reading from a first disk media surface;
while receiving said first signal, concurrently receiving a second read signal from a second reader reading from a second disk media surface different from said first disk media surface; and
passing at least one signal, based on said first read signal and said second read signal, for determining the relative motion between said first reader and said second reader.

14. The hard disk drive integrated circuit of claim 13, said one or more sequences of instructions which, when executed by one or more processors, cause performance of:
selecting said first reader from which to receive said first read signal, and
selecting said second reader from which to concurrently receive said second read signal.

15. The hard disk drive integrated circuit of claim 14, said one or more sequences of instructions which, when executed by one or more processors, cause performance of:
after selecting said second reader from which to concurrently receive said second read signal, selecting a third reader from which to receive a third read signal from said third reader reading from a third disk media surface concurrently with receiving said first read signal from said first reader, wherein said third reader is different from said second reader and said third disk media surface is different from said second disk media surface.

16. The hard disk drive integrated circuit of claim 13, wherein receiving said first read signal and concurrently receiving said second read signal includes receiving said first read signal from a reference head during a self-servo write process and receiving said second read signal from a non-reference head during said self-servo write process.

17. The hard disk drive integrated circuit of claim 16, wherein said first read signal and said second read signal include position information.

18. The hard disk drive integrated circuit of claim 16, wherein said first disk media surface is from a first disk media and said second disk media surface is from a second disk media different from said first disk media.

19. The hard disk drive integrated circuit of claim 16, wherein said first disk media surface and said second disk media surface are opposing sides of the same disk media.
